(19) United States
(12) Patent Application Publication
(10) Pub. No.: US 2001/0044821 A1
(43) Pub. Date: Nov. 22, 2001

(54) Distributed data processing system for use with limited function computing devices

(75) Inventor: Daniel S. Dunkin, Gastonia, NC (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: Picoapp. Inc., Fort Myers Beach, FL (US)

(21) Appl. No.: 09/858,731

(22) Filed: May 16, 2001

Related U.S. Application Data
(60) Provisional application No. 60/205,175, filed on May 17, 2000.

(51) Int. Cl. G06F 15/16

(52) U.S. Cl. 709/202

(57) ABSTRACT

A distributed data processing system for use with a limited function computing device communicatively linked to a Web server. The system can include a server-side application programmed to perform a data processing task; a task interface for mediating data communications between the Web server and the server-side application, and a client application executing in the limited function computing device. The task interface can be pre-configured to interact with the server-side application. Similarly, the client application can be pre-configured to interact with the task interface through the Web server. Notably, the client application can include a data encapsulator for encapsulating data processing requests and corresponding request parameters in a hypertext transfer protocol (HTTP) request.

### CROSS REFERENCE TO RELATED APPLICATIONS

This Application claims the priority of United States provisional patent application No. 60/205,175 filed May 17, 2000.

### BACKGROUND OF THE INVENTION

1. Field of the Invention

This invention relates to limited function computing devices and more particularly to a distributed application communication system for use with limited function computing devices.

2. Description of the Related Art

Since the advent of the local area network, client applications have accessed distributed data through two models of distributed data processing. In the first model, the “Client-Server” model, requests for data processing originate in a client computer and are forwarded to a server computer. Where the server is essentially an enterprise data store such as a database, and the request for data processing is a database query, the server can perform the database query and can return to the client computer a result set. In contrast, where the server includes a server-side application and the request for data processing is a trigger for performing more complex server-side logic, the server-side application can perform the requested server-side logic.

Although generally useful for applications having a relatively small number of client computing devices, the Client-Server model is not well suited for servicing a large number of client computing devices for several reasons. First, client application programs required to access the server must be installed in each client computer. In consequence, all changes to the client application program, such as upgrades and maintenance patches must be applied to each client computer. Second, the Client-Server model is not conducive for enforcing the software development best practices guideline of separating business logic (rules for data access) from the client application logic. In particular, while it is theoretically possible to separate the business logic from the client application, this separation is not generally implemented in practice because the user interface executing in the client computer can be affected by the business logic. Hence, some business logic is included in the client computer.

Code security also can be compromised in the Client-Server model because the object code, including some business logic, is deployed on all client computers, resulting in hundreds or even thousands necessary copies of the code and business logic which must be maintained. Similarly, because encryption generally is not incorporated in the Client-Server design, a motivated outsider able to duplicate an appropriate server access data stream without the client application can access the server including any databases contained therein. Accordingly, in a public environment such as the Internet, database servers deployed in a Client-Server setting can be subject to unwanted hacking attempts.

In the second distributed data processing model, the “3-Tier” or “N-Tier” model, the limitations of the Client-Server model are addressed. Specifically, in the N-Tier model, the client computer interacts with the server in a view-only mode such as through a Web browser. In this way, specific client application software is not required to access the server. Rather, from an enterprise application developer's point of view, it is assumed that the client computer has access to appropriate software such as a Web browser to access the server. In operation, the client computer transmits a data processing request to the server. The server combines the request with server-side business logic which results in a data processing query to an enterprise data store. The enterprise data store performs the query returning a result set to the server which formats a reply containing the requested data. The formatted repy can be provided to the client computer and the result set can be viewed therein, typically through a Web browser interface. Notably, in the N-Tier model, the server often can make several requests to the enterprise data store in order to properly format the reply.

Hence, the N-Tier model solves many of the problems associated with the Client-Server model. For example, in the N-Tier model, the client application is not included as part of the deployed distributed data system. Rather, it is assumed that the client computer can interact with the distributed data system using a third-party viewer such as a Web browser. Second, business logic is stored wholly in the server and not in the client computer. Consequently, the business logic can change without further compelling mass modifications of client applications deployed across hundreds, or even thousands of client computers.

Finally, security is improved where the distributed data system is deployed in a public environment in as much as enterprise data store is not directly exposed to the public. Rather, the server exclusively handles all data processing requests received from client computers. Only once a data processing request has been received in the server can the request be forwarded to the enterprise data store. Moreover, encryption technology is routinely utilized in communications between Web browsers and Web servers.

Nevertheless, although the N-Tier model can be effective when applied to traditional systems which include ordinary client computing devices such as desktop personal computers, the N-Tier model does not address the requirements of limited function computing devices. Limited function computing devices include the class of devices exemplified by handheld computers, personal digital assistants, vehicle mounted computers, intelligent barcode readers, cellular telephones, and the like. Limited function computing devices differ from conventional personal computers in that limited function computing devices have limited computing resources such as processing power and memory.

Limited function computing devices also differ from conventional computers in that limited function computers enjoy at best, limited connectivity bandwidth. In particular, while a desktop computer can generally communicate over a local area network at 100 Mbit/s and across the Internet at 1.5 Mbit/sec, typical limited function computing devices communicate with other computing devices at merely 19.2 Kbit/s. Hence, the communication rate of a limited function computing device ranges from 100 to 5000 times slower compared to a conventional computing devices. Finally, limited function computing devices do not enjoy the robust display screen capabilities of a conventional desktop computer. Rather, limited function computing devices typically include only a basic, small display screen which is incapable of presenting a robust user interface.

Presently, software development for limited function computing devices can be characterized as following one of two design philosophies. One philosophy includes creating small, specific-purpose client applications that provide access to a subset of data required to perform a desired task in the limited function computing device. This philosophy typically implements the Client-Server model. By comparison, the second philosophy includes providing a limited function Web browser (microbrowser) through which a user can interact with an application server. Notably, microbrowsers are unable to process conventionally formatted Web content. Hence, microbrowsers require Web servers to provide proprietarily formatted content so that the microbrowser can appropriately process the content. This second philosophy typically implements the N-Tier model.

Notwithstanding, both the Client-Server and N-Tier models can be problematic in is the context of limited function computing devices. Specifically, in the Client-Server model, a proprietary database interface can require a larger than desired portion of available memory in the limited function computing device. As a result, in some cases, applications developers have neglected to develop Client-Server software for entire classes of limited function computing devices because of the inability of the database manufacturer to reduce the size of the database interface to accommodate certain limited function computing devices. Furthermore, the differing resources among various limited function computing devices can require differing database interfaces for each device.

By comparison, in the N-Tier model, a microbrowser must be developed in a general manner so as to format content provided by any particular Web server. This generalization requirement, however, can increase the application size of the microbrowser necessitating the removal of other applications from the limiting function computing device. Additionally, Web servers may be required to modify the formatting of a reply to the microbrowser in order to accommodate differences among various microbrowsers. Hence, if many different client types are employed, the Web server generally must perform different data transformations for each client type. This additional programming requirement can lead to incompatibility, poorly formatted responses, a “least common denominator” effect by implementing standards to reach a wider target device audience, and additional processing required by the Web server.

Thus, both the Client-Server and N-Tier models have not provided an adequate solution to processing distributed data using limited function computing devices. In consequence, there exists a long felt, unsolved need for a system and method of distributed data processing in which limited function computing devices can interact with server-side applications while avoiding the deficiencies of the prior art caused by the scarce resources of limited function computing devices.

### SUMMARY OF THE INVENTION

A distributed data processing system and method for use with limited function computing devices is disclosed which overcomes the deficiencies of the prior art and provides a novel and non-obvious system and method for distributed data processing in a network architecture which includes limited function computing devices such as handheld computers, cellular phones, embedded systems and the like. Specifically, a distributed data processing system for use with a limited function computing device communicatively linked to a Web server can include a server-side application programmed to perform a data processing task; a task interface for mediating data communications between the Web server and the server-side application, and a client application executing in the limited function computing device.

The task interface can be pre-configured to interact with the server-side application. Similarly, the client application can be pre-configured to interact with the task interface through the Web server. Notably, the client application can include a data encapsulator for encapsulating data processing requests and corresponding request parameters in a hypertext transfer protocol (HTTP) request. Likewise, the task interface can include a data parser for extracting the encapsulated data processing requests and corresponding request parameters from the HTTP request. In one aspect of the present invention, the task interface can be a common gateway interface (CGI) script having a pre-configured reference to the server-side application. Also, the client application can include a user interface through which a user can provide data processing parameters for use by the server-side application; a communications protocol stack interface for establishing a communications link with the Web server using a specified protocol stack; and, a request formatter for formatting the data processing parameters into an HTTP request and for transmitting the HTTP request over the established communications link to the Web server.

From the perspective of the limited function computing device, a distributed data processing method in accordance with the inventive arrangements can include the steps of: generating a user interface through which a user can request data processing by a server-side application; identifying task interfaces which have been configured to forward selected data processing requests to corresponding server-side applications; formatting references to the identified task interfaces into data processing requests recognizable by a Web server; and, forwarding the formatted data processing requests to the Web server. In consequence, the Web server can extract references to identified task interfaces from respective formatted data processing requests, and the Web server can call the identified task interfaces referred to by the extracted references. Subsequently, the identified task interfaces can forward the data processing requests to associated server-side applications; and, the server-side applications can perform data processing consonant with the data processing requests. Notably, in one aspect of the invention, the formatting step can include the step of encapsulating references to the identified task interfaces in an HTTP request. In that case, the forwarding step can include the step of transmitting HTTP GET requests containing the encapsulated references to the Web server.

By comparison, from the perspective of the Web server, a distributed data processing method can include the steps of: receiving formatted data processing requests from client applications; extracting references to identified task interfaces from the received formatted data processing requests; and, calling the identified task interfaces referred to by the extracted references. In consequence, the identified task interfaces can forward the data processing requests to associated server-side applications and the server-side applications can perform data processing consonant with the data processing requests. Similar to limited function computing device, in the Web server, the receiving step can include the step of receiving HTTP GET requests containing encapsulated references to the identified task interfaces. In this case, the extracting step can include the step of extracting from the HTTP GET requests the encapsulated references to the identified task interfaces. Subsequently, the calling step can include the step of executing CGI scripts configured to forward the data processing requests to associated server-side applications. In consequence, the server-side applications can perform data processing consonant with the data processing requests.

Hence, from a whole-system perspective, a distributed data processing method can include steps performed both in a limited function computing device and in a Web server. First, in a client application executing in a limited function computer, a user interface can be generated through which a user can request data processing by a server-side application. A task interface can be identified which has been configured to forward a selected data processing request to a corresponding server-side application. Subsequently, a reference to the identified task interface can be formatted into a data processing request recognizable by a Web server. Once formatted, the data processing request can be forwarded to the Web server.

Second, in the Web server, the formatted data processing request can be received from the client application. The identified task interface can be extracted from the received formatted data processing request; and, the Web server can call the identified task interface referred to by the extracted reference. When called, the identified task interface can forward the data processing request to the associated server-side application and the server-side application can perform data processing consonant with the data processing request.

A method of configuring a distributed data processing system for use with limited function computing devices can include the steps of: installing a client application in a limited function computing device through which a user can request data processing by a server-side application; installing through a common gateway interface (CGI) associated with a Web server, a task interface script for forwarding a data processing request to the server-side application; and, programmatically embedding a hypertext transfer protocol (HTTP) request in the client application, the HTTP request containing a reference to the task interface script which when received in the Web server can cause the task interface script to execute, the execution forwarding the data processing request to the server-side application.

### BRIEF DESCRIPTION OF THE DRAWINGS

There are presently shown in the drawings embodiments which are presently preferred, it being understood, however, that the invention is not limited to the precise arrangements and instrumentalities shown.

FIG. 1 is a schematic representation of a distributed data processing system configured in accordance with the inventive arrangements.

FIG. 2 is a block diagram of the distributed data processing system of FIG. 1.

FIG. 3 is a flow chart of illustrating the operation of the distributed data processing system of FIG. 1

### DETAILED DESCRIPTION OF THE INVENTION

The present invention is a system and method for distributed data processing using one or more limited function computing devices. In the present invention, a limited function computing device can forward a properly formatted data processing request to a Web server. A data processing request can range from a simple database query to a more complex task requiring the execution of server-side business logic. Notably, the data request optionally can include corresponding parameters for use in performing the requested data processing.

Upon receiving the request, the Web server can extract therefrom a reference to a task interface. The task interface can be a program such as a compiled object such as a C or Java-based program, or an interpretable script, such as a Javascript, VBScript or a common gateway interface (CGI) script which can be configured to execute a server-side application when called upon by the Web server. In consequence, when the Web server calls the task interface, the task interface can initiate the execution of the server-side application passing thereto any corresponding parameters. As a result, the server-side application can perform data processing which is consonant with the data processing request originally provided by the limited function computing device.

Significantly, the present invention relies neither on a Client-Server model nor an N-Tier model. Rather, the present invention utilizes a unique approach which enables limited function computing devices to access more data and perform increasingly complex tasks. Specifically, by requiring a client application in a limited function computing device to formulate data processing requests in a manner that a standard Web server can process, users may utilize the benefit of applications specifically designed and formatted for limited function computing devices while utilizing the simple and robust communications ability of a Web server. No modifications need be applied to the Web server to accommodate variations in the configuration of various limited function computing device clients. The Web server need only respond to the specific data processing requests provided by the client application. Moreover, the limited function computing device need not include a database interface which contains complex business logic. Rather, the database interface can be provided centrally in an application server. Hence, the unique approach of the present invention does not consume resources in the limited function computing device as would be the case in either the Client-Server model or the N-Tier model.

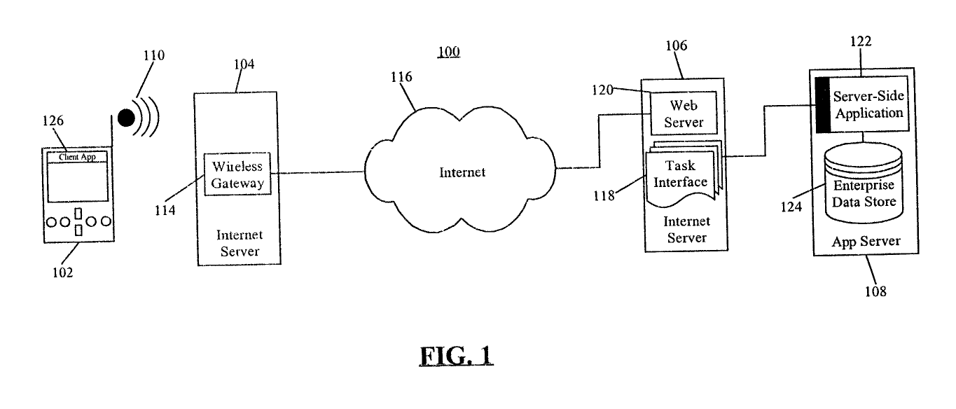

FIG. 1 is a schematic diagram of a distributed data processing system 100 configured in accordance with the inventive arrangements. The system 100 can include a limited function computing device 102 communicatively linked across wireless link 110 to a wireless gateway 114 disposed in a first server 104. The wireless gateway 114 can be communicatively linked to a second server 106 across computer communications network 116 such as the Internet. The second server 106 can include a conventional Web server 120 which can respond to properly formed requests which comport with the hypertext transfer protocol (HTTP). The Web server, in turn, can access task interfaces 118 which can be executable scripts such as CGI scripts.

Each task interface 118 can be configured to call the execution of a server-side application 122 residing in a third server 108. The server-side application 122 can be communicatively linked to an enterprise data store 124 such as a database to and from which the server-side application 122 can write and read data stored therein. Notably, although the server-side application 122 and enterprise data store 124 are shown is residing in a third server 108 which is separate from the second server 106, the invention is not so limited and the Web server 120, task interfaces 118, server-side application 122 and enterprise data store 124 can be combined in a single server, or can be distributed across any number of servers.

Though shown in FIG. 1 as a handheld device, the limited function computing device 102 can be any suitable limited function computing device such as an intelligent cellular telephone or on-board vehicle computer. In any case, in accordance with the inventive arrangements, the limited function computing device 102 has a user interface 126 through which a user can interact with the server-side application 122. Additionally, though one aspect of the invention contemplates communications between the user interface 126 and the Web server 120 which comports with the HTTP protocol, the invention also is not so limited and other communications protocols can suffice, such as both connection-oriented and connectionless communications through other transport control protocol (TCP) ports, so long as a conventional Web server can recognize and amply parse a data processing request comporting therewith without requiring modification of the Web server.

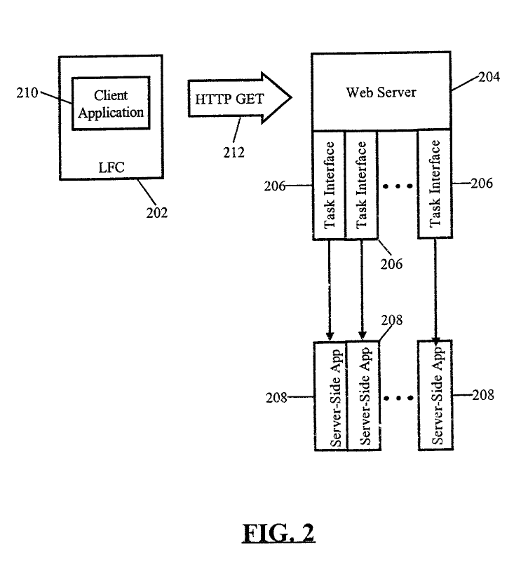

FIG. 2 is a block diagram which illustrates one aspect of operation of the distributed data processing system 100 of FIG. 1. First, a client application 210 in a limited function computing device 202 and the Web server can communicate using an HTTP GET operator. Specifically, a particular task interface 206 associated with a desired data processing task can be identified in the client application 210. Subsequently, associated parameters for use with the data processing task can be determined. Finally, a reference to the identified task interface 206 and the associated parameters, if any, can be encapsulated in an HTTP GET request 212. Once the HTTP GET request 212 has been properly formatted, the request 212 can be forwarded to the Web server 204 using conventional means.

Once the Web server 204 has received the HTTP GET request 212, the Web server 204 can extract therefrom the reference to the selected task interface 206. Once extracted, the Web server 204 can conventionally invoke the task interface 206 as would be the case with any other conventional script such as a Javascript, VBScript, or CGI script. The identified task interface 206, when invoked by the Web server 204, can communicate with a corresponding server-side application 208 using the application interface specified by the server-side application 208. For example, if the server-side application is an ordinary database, the task interface 206 can communicate with the corresponding server-side application 208 using the database's published interface.

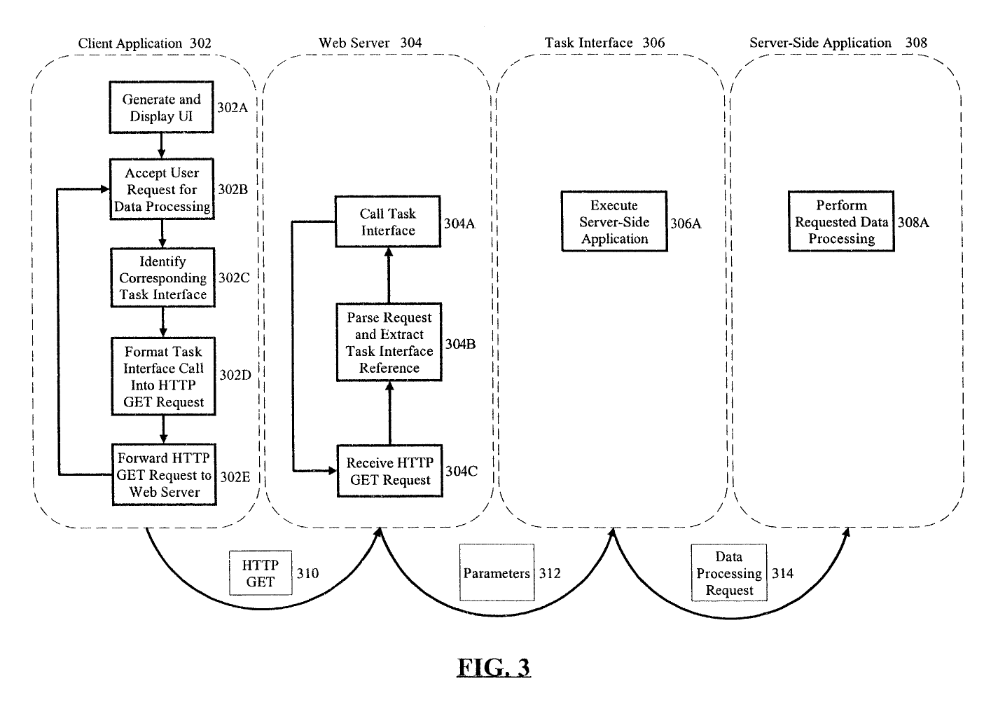

FIG. 3 is a flow chart illustrating a method for distributed data processing which spans four nodes in the system 100 of FIG. 1, the client application 302, the Web server 304, the task interface 306, and the server-side application 308. Beginning first in the client application 302, in block 302A a user interface in the client application can be generated so as to provide structure for a user to interact with the server-side application 308. Notably, the invention is not limited in regard to the complexity of the client application 302. Rather, the user interface can be a complex application, or a simple, single operation applet. In any case, in block 302B, the client application 302 can receive a user request for data processing.

As noted above, the data processing can be as simple as requesting the server-side application 308 record the current time in an enterprise data store, or as complex as assembling a regional sales report based on a supplied date range. Regardless, in block 302C, a task interface 306 can be identified as having a corresponding server-side application 308 which can perform the desired data processing task. In block 302D, the identified task interface 306 and any associated parameters can be formatted into an HTTP GET request 310. Finally, in block 302E, the HTTP GET request 310 can be forwarded to the Web server 304 in a conventional fashion.

Turning now to operations performed in the Web server 304, in block 304A, the HTTP GET request 310 can be received in conventional fashion. In step 304B, the Web server 304 can parse the HTTP GET request 310 producing in block 304B an extracted task interface 306 reference. Once the reference to the task interface 306 has been extracted, the Web server 304 can call the task interface in block 304C in the same manner as a conventional Web server can call a script specified in a properly formed hypertext markup language (HTML) document. Notably, at this time any parameters 312 provided with the data processing request can be forwarded to the task interface 306.

In block 306A, the task interface 306 can establish a communications link with the server-side application 308 and pass a data processing request 314 thereto in conformance with the application interface of the server-side application 308. For example, where the server-side application 308 is a conventional database, the task interface 306 can form a structured query language (SQL) query for retrieving data specified by the data processing request in the HTTP GET request 310. In block 308A, the server-side application 308 can received the data processing request 314 and can perform one or more data processing operations which comport with the data processing request initially issued in the client application 302. Notably, the server-side application 308 can optionally provide a result set in response to the data processing request. In that case, the task interface 306 can reformat the data in a manner suitable for communications using the HTTP protocol and can provide the result set to the client application 302 via the Web server 304.

Using the unique communications model of the present invention, a distributed data applications developer can receive both the benefits of the Client-Server model and the benefits of the N-Tier model when applied to the limited function computing device context. Benefits derived from the Client-Server model can include a reduced memory requirement for the client application resulting in the ability to deploy a given client application over a wider range of devices. Benefits derived from the N-Tier model can include stateless communications between the client application and the Web server.

Also, removing the requirement for an open database connection makes the client application less susceptible to errors that occur due to lost communications (a common problem for radio-communication limited function computing devices). Furthermore, by deploying business logic in a server and not in the client, the communications model of the present invention allows for the development of client applications that are significantly more complicated than those that can operate in a limited function computing device alone.

Finally, the communications model of the present invention facilitates the simple deployment of applications. While not as simple as a pure N-Tier model, application distribution under the communications model of the present invention is simpler than the Client-Server model because the client application is used merely as an interface for the end user. Thus, only changes in the user interface necessitate an update of the client application. In contrast, changes in the business logic can be performed solely in the Web server, task interface or server-side application as the case may be.

The present invention can be realized in hardware, software, or a combination of hardware and software. Moreover, the present invention can be realized in a centralized fashion in one computer system, or in a distributed fashion where different elements are spread across several interconnected computer systems. Any kind of computer system—or other apparatus adapted for carrying out the methods described herein—is suited.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A distributed data processing system for use with a limited function computing device communicatively linked to a Web server comprising:
a server-side application programmed to perform a data processing task;
a task interface for mediating data communications between the Web server and said server-side application, wherein said task interface is pre-configured to interact with said server-side application; and,
a client application executing in the limited function computing device, wherein said client application is pre-configured to interact with said task interface through the Web server.

2. The distributed data processing system of claim 1, wherein:
said client application comprises a data encapsulator for encapsulating data processing requests and corresponding request parameters in a network request; and,
said task interface comprises a data parser for extracting said encapsulated data processing requests and corresponding request parameters from said network request.

3. The distributed data processing system of claim 2, wherein said network request is a hypertext transfer protocol (HTTP) request.

4. The distributed data processing system of claim 1, wherein said task interface is a script having a pre-configured reference to said server-side application.

5. The distributed data processing system of claim 3, wherein said script is a common gateway interface (CGI) script.

6. The distributed data processing system of claim 1, wherein said client application comprises:
a user interface through which a user can provide data processing parameters for use by said server-side application;
a communications protocol stack interface for establishing a communications link with the Web server using a specified protocol stack; and,
a request formatter for formatting said data processing parameters into an network request and for transmitting said network request over said established communications link to the Web server.

7. The distributed data processing system of claim 1, wherein said network request is a hypertext transfer protocol (HTTP) request.

8. A distributed data processing method comprising the steps of:
generating a user interface through which a user can request data processing by a server-side application;
identifying task interfaces which have been configured to forward selected data processing requests to corresponding server-side applications;
formatting references to said identified task interfaces into data processing requests recognizable by a Web server; and,
forwarding said formatted data processing requests to said Web server, whereby
(1) said Web server can extract references to identified task interfaces from respective formatted data processing requests;
(2) said Web server can call said identified task interfaces referred to by said extracted references;
(3) said identified task interfaces can forward said data processing requests to associated server-side applications; and,
(4) said server-side applications can perform data processing consonant with said data processing requests.

9. The method of claim 8, wherein said formatting step comprises the step of encapsulating references to said identified task interfaces in a hypertext transfer protocol (HTTP) request.

10. The method of claim 9, wherein said forwarding step comprises the step of transmitting HTTP GET requests containing said encapsulated references to said Web server.

11. A distributed data processing method comprising the steps of:
receiving formatted data processing requests from client applications;
extracting references to identified task interfaces from said received formatted data processing requests; and,
calling said identified task interfaces referred to by said extracted references; whereby said identified task interfaces can forward said data processing requests to associated server-side applications and said server-side applications can perform data processing consonant with said data processing requests.

12. The method of claim 11, wherein said receiving step comprises the step of receiving HTTP GET requests containing encapsulated references to said identified task interfaces.

13. The method of claim 12, wherein said extracting step comprises the step of extracting from said HTTP GET requests said encapsulated references to said identified task interfaces.

14. The method of claim 13, wherein said calling step comprises the step of executing common gateway interface (CGI) scripts configured to forward said data processing requests to associated server-side applications whereby said server-side applications can perform data processing consonant with said data processing requests.

15. A distributed data processing method comprising the steps of:
(1) in a client application executing in a limited function computer:
(a) generating a user interface through which a user can request data processing by a server-side application;
(b) identifying a task interface which has been configured to forward a selected data processing request to a corresponding server-side application;
(c) formatting a reference to said identified task interface into a data processing request recognizable by a Web server; and,
(d) forwarding said formatted data processing request to said Web server;
(2) in said Web server:
(a) receiving said formatted data processing request from said client application;
(b) extracting said reference to said identified task interface from said received formatted data processing request; and,
(c) calling said identified task interface referred to by said extracted reference;
whereby said identified task interface can forward said data processing request to an associated server-side application and said server-side application can perform data processing consonant with said data processing request.

16. The method of claim 15, wherein said formatting step comprises the step of encapsulating said reference to said identified task interface in a hypertext transfer protocol (HTTP) request.

17. The method of claim 16, wherein said forwarding step comprises the step of transmitting an HTTP GET request containing said encapsulated reference to said Web server.

18. The method of claim 17, wherein said receiving step comprises the step of receiving said HTTP GET request containing said encapsulated reference to said identified task interface.

19. The method of claim 18, wherein said extracting step comprises the step of extracting from said HTTP GET request said encapsulated references to said identified task interface.

20. The method of claim 19, wherein said calling step comprises the step of executing a common gateway interface (CGI) script configured to forward said data processing request to said associated server-side application whereby said server-side application can perform data processing consonant with said data processing request.

21. A method of configuring a distributed data processing system for use with limited function computing devices comprising the steps of:
installing a client application in a limited function computing device through which a user can request data processing by a server-side application;
installing through a common gateway interface (CGI) associated with a Web server, a task interface script for forwarding a data processing request to said server-side application; and,
programmatically embedding a hypertext transfer protocol (HTTP) request in said client application, said HTTP request containing a reference to said task interface script which when received in said Web server can cause said task interface script to execute, said execution forwarding said data processing request to said server-side application.

22. A machine readable storage having stored thereon a computer program having a plurality of code sections executable by a machine for causing the machine to perform the steps of:
generating a user interface through which a user can request data processing by a server-side application;
identifying task interfaces which have been configured to forward selected data processing requests to corresponding server-side applications;
formatting references to said identified task interfaces into data processing requests recognizable by a Web server; and,
forwarding said formatted data processing requests to said Web server, whereby
(1) said Web server can extract references to identified task interfaces from respective formatted data processing requests;
(2) said Web server can call said identified task interfaces referred to by said extracted references;
(3) said identified task interfaces can forward said data processing requests to associated server-side applications; and,
(4) said server-side applications can perform data processing consonant with said data processing requests.

23. The machine readable storage of claim 22, wherein said formatting step comprises the step of encapsulating references to said identified task interfaces in a hypertext transfer protocol (HTTP) request.

24. The machine readable storage of claim 23, wherein said forwarding step comprises the step of transmitting HTTP GET requests containing said encapsulated references to said Web server.

25. A machine readable storage having stored thereon a computer program having a plurality of code sections executable by a machine for causing the machine to perform the steps of:
receiving formatted data processing requests from client applications;
extracting references to identified task interfaces from said received formatted data processing requests; and,
calling said identified task interfaces referred to by said extracted references; whereby said identified task interfaces can forward said data processing requests to associated server-side applications and said server-side applications can perform data processing consonant with said data processing requests.

26. The machine readable storage of claim 25, wherein said receiving step comprises the step of receiving HTTP GET requests containing encapsulated references to said identified task interfaces.

27. The machine readable storage of claim 26, wherein said extracting step comprises the step of extracting from said HTTP GET requests said encapsulated references to said identified task interfaces.

28. The machine readable storage of claim 27, wherein said calling step comprises the step of executing common gateway interface (CGI) scripts configured to forward said data processing requests to associated server-side applications whereby said server-side applications can perform data processing consonant with said data processing requests.
